(19) United States
(12) Patent Application Publication
(10) Pub. No.: US 2006/0293915 A1
(43) Pub. Date: Dec. 28, 2006

(54) Method for optimizing accuracy of real estate valuations using automated valuation models

(76) Inventors: Christopher Edward Glenn, Berkeley, CA (US); Curtis K. Yee, San Francisco, CA (US)

Correspondence Address: WILSON DANIEL SWAYZE, JR., 3804 CLEARWATER CT., PLANO, TX, 75025, US

(21) Appl. No.: 11/474,548

(22) Filed: Jun. 26, 2006

Related U.S. Application Data
(60) Provisional application No. 60/693,812, filed on Jun. 24, 2005.

(51) Int. Cl. G06Q 99/00

(52) U.S. Cl. 705/1

(57) ABSTRACT

A method for obtaining a real estate valuation using an automated valuation model includes accessing a confidence score corresponding to a real estate property for the real estate valuation; forming a plurality of confidence scores from accessing the confidence score; assigning a standardized value to the confidence scores, arranging the plurality of standardized values from highest to lowest; and selecting an automated valuation model report based on said arrangement of said plurality of standardized values.

### PRIORITY

The present invention claims priority based on 35 USC section 119 and based on provisional application 60/693,812 filed on Jun. 24th, 2005.

### BACKGROUND OF THE INVENTION

The present invention relates generally to estimating the value of a real estate property including improvements.

Financial institutions and businesses involved with selling mortgage loans have long tried to assess the value of real estate property accurately. For example, financial institutions use the estimated value of real estate property as one of the important factors in approving mortgage loan applications. Relying on the soundness of the estimate, financial institutions accept the risk of lending large sums of money and attach the real estate property as security for the transaction. In this sense, the accuracy of estimated value of the real estate entity is critical.

In addition to the accuracy of the estimate, timeliness is a significant factor. For example, mortgage loan contracts often guarantee a certain interest rate for a defined number of days, which is often referred to as the interest rate lock period. Should the mortgage loan not close prior to the expiration of the interest rate lock period, the loan's interest rate may increase due to market conditions resulting in potential borrowers abandoning a lender to seek a loan with a better interest rate. Hence, it is important for lenders to be able to estimate the value of the real estate property quickly.

Traditionally, real estate personnel performed appraisals manually, but this poses many problems. First, manual appraisals are subjective and vary depending on the appraiser. Second, manual appraisals are expensive. Third, manual appraisals may not be timely due to many unpredictable conditions such as appraiser availability, scheduling conflicts, and weather conditions.

Some have tried to automate the real estate valuation process. For example, Jost et al., U.S. Pat. No. 5,361,201, discloses a neural network-based system for automated real estate valuation. It also discusses other efforts and problems with using statistical models to value real estate properties. In its discussion, Jost et al. points out deficiencies of traditional statistical techniques in estimating real estate property values, namely the inability to capture the complexity and the changing trend of the data. It also discusses difficulties involved with selecting a proper sample size for a statistical model to achieve an acceptable stability and reliability of the estimate.

U.S. Pat. No. 6,609,109 discloses a method for obtaining estimate values of real estate entities by combining the results of models in an appropriate manner.

For loans secured by real estate, lenders employ various methods to determine the approximate market value for real estate collateral. One method for real estate valuation that is increasingly being used by lenders is the use of Automated Valuation Models (AVMs). AVMs are powered by computer software that generate an estimated value 104 of real estate properties.

Examples of AVMs offered in the market that lenders use to obtain estimated market values of real estate properties include AVM vendors: Freddie Mac's Home Value Explorer (HVE), Veros Software Inc.'s (VeroVALUE), Fiserv CSW, Inc.'s (CASA), First American Real Estate Solutions L.P.'s Home Price Analyzer (HPA) and First American Real Estate Solutions L.P.'s (PASS). Although the list is not exhaustive and for purposes of explanation, the above list will be referred to as AVM vendors. FIG. 1 illustrates the type of information typically found in an AVM report 100 which details the information collected by the AVM vendor for a given real estate property. The AVM report 100 may include a real estate property identifier 102 to identify the real estate property and an estimated value 104 which is the estimated value 104 of the real estate property.

The AVM reports 100 usually include additional information relating to the real estate property including comparable real estate property sales 106, an estimated high market value 108 which provides an indication of the high potential market value of the real estate property and an estimated low market value 110 which is an indication of the low market value of the real estate property. Another important data element that most AVM reports 100 contain is an indicator that relates to the accuracy of the AVM report's estimated value 104 of the subject real estate property 102. This accuracy indicator may have differing labels among AVM reports such as “Confidence Score”, “Score”, “Safety Score” and “Confidence,” but is commonly referred to in the industry as the “Confidence Score” and will hereinafter be referred to as “Confidence Score” 112 in this document. The Confidence Score 112 scales used by AVM vendors vary where some AVM vendors use alpha values, such as H, M, L, and some AVM vendors use numeric values, such as 1-100. Usually, the higher the Confidence Score 112, the greater the expected accuracy of the estimated value 104.

Lenders order AVM reports 100 using a computer with an online connection either directly to the computers of AVM vendors or via an online connection to intermediary computers that manage the ordering of AVM reports 100 from the AVM vendors. When ordering an AVM report 100, a lender will input the subject real estate property identifier 102 which includes the address and/or legal description of the real estate property into a computer which electronically communicates the request for the AVM report 100 to the AVM vendor's computer. The AVM vendor's computer will then electronically communicate a reply that either includes an AVM report 100 or a message that indicates it was unable to generate the AVM report 100.

The term “online connection” means the electronic communication between computer systems that could include a computer network, such as the Internet, and more particularly, the World Wide Web (the “Web”).

The AVM report 100 will often provide an estimated value 104 for a real estate property identifier 102, but with a Confidence Score 112 that is below the acceptable criteria set by the lender. Lenders will often set minimum Confidence Score 112 criteria for acceptance of an AVM report 100. The AVM Confidence Scores 112 that are below the lender's minimum Confidence Score 112 criteria are deemed to be too inaccurate to be used.

However, another AVM vendor may have returned an AVM report 100 for the real estate property identifier 102 with a Confidence Score 112 that has a greater expected accuracy, and consequently, this AVM report 100 may have a Higher Confidence Score 112. It is common for a first AVM vendor to generate an AVM report 100 for a real estate property identifier 102 with a relatively high Confidence Score 112 while another AVM report 100 from a second AVM vendor will either not be able to generate an estimate of market value 104 for the real estate property identifier 102 or will generate an estimate of market value 104 for a real estate property identifier 102 but with an unacceptably low Confidence Score 112. The differing AVM report 100 Confidence Scores 112 and associated expected accuracy creates problems for lenders when attempting to evaluate the value of the real estate collateral for loans. Given the varying performance of AVM reports 100, lenders commonly utilize multiple AVM reports 100 at a given time where lenders often will sequentially order AVM reports 100 until an AVM report 100 that meets or exceeds the lender's minimum acceptable criteria for acceptance is obtained. Using a computer with an online connection to the computers of AVM vendors, lenders will either manually sequentially order the AVM reports 100 or will use a computer software program to automatically sequentially order AVM reports 100 until an AVM report 100 is returned that satisfies the lender's minimum criteria for acceptance, which could include minimum Confidence Score 112 criteria.

The term “Cascading AVM search” is a method used to automate the ordering of AVM reports 100 in a defined ordering sequence using a computer software program.

The term “Cascading AVM Engine” is a computer software program that performs a Cascading AVM search.

When lenders use Cascading AVM Engines, they usually define the sequence of AVM reports 100 to be ordered by the Cascading AVM Engine. For example, the lender may setup the Cascading AVM Engine to first order HVE, and then order CASA, and then order VeroVALUE and then order HPA. Whether or not the Cascading AVM Engine orders the next AVM in the sequence depends on the ordering criteria or rules setup in the Cascading AVM Engine. Usually, once all of the AVM report 100 ordering rules have been satisfied, the Cascading AVM Engine stops requesting AVM reports 100.

One of the problems identified is that the use of Cascading AVM Engines by lenders often yield poor results at a high cost. When a lender submits a Cascading AVM search request, the Cascading AVM Engine will often return multiple AVM reports 100 with none of the AVM reports meeting the lender's minimum acceptable Confidence Score 112 criteria. In this case, the lender must pay for multiple AVM reports 100, but is unable to use any of the AVM reports 100.

Another problem identified is that when lenders use a Cascading AVM Engine to order AVM reports 100 in a fixed cascade sequence from multiple AVM vendors, the lender is likely to receive an AVM report 100 with a Confidence Score 112 that has a lower expected accuracy than would have been provided by one of the other AVM vendors in the AVM cascade sequence. Since Cascading AVM Engines typically order AVM reports 100 one at a time in a defined fixed sequence until an AVM report 100 is returned which satisfies the lender's minimum criteria for acceptance, the AVM Cascading Engine will not continue to order AVM reports 100 after an acceptable AVM report 100 is received. As the number of AVM reports 100 used in a Cascading AVM Engine increases, the greater the likelihood that the first AVM report 100 that meets the lender's minimum criteria for acceptance will not be the AVM report 100 with the Confidence Score 112 with the greatest expected accuracy of what would have been provided by the one other AVM vendors in the fixed AVM cascade ordering sequence.

### SUMMARY OF THE INVENTION

Having identified the aforementioned problems in the existing methods for using multiple Automated Valuation Model (AVM) reports ordered in a fixed sequence to determine an estimated market value of a real estate property identifier, the inventors have developed the method of the present invention. The inventors have developed a Cascading AVM search method and system that dynamically sets the Cascading AVM search sequence per request based on the expected accuracy associated with the AVM Confidence Scores to improve the accuracy of the Cascading AVM search results.

The present invention involves the use of a Cascading AVM Engine which orders AVM reports in a sequence that is dynamically determined at the beginning of each Cascading AVM search. For each Cascading AVM request, the Cascading AVM Engine of the present invention determines and sets the AVM report ordering sequence using a standardized value that correlates to the expected accuracy of the Confidence Score values of the AVMs setup in the Cascading AVM Engine. The Cascading AVM Engine of the present invention first obtains the Confidence Score values from the computers of the AVM vendors setup in the Cascading AVM Engine for a real estate property identifier and then looks up a standardized value for each AVM's Confidence Score and then sorts the Cascading AVM ordering sequence by the standardized values of each AVM in descending order from the standardized value with the greatest expected accuracy to the standardized value with the least expected accuracy. The Cascading AVM Engine of the present invention then sets the AVM Cascade search ordering sequence in the order set in the prior step. After the Cascading AVM Engine of the present invention has determined the AVM ordering sequence, the Cascading AVM Engine of the present invention will then sequentially order the AVM reports in the sequence set in the prior step until an AVM report is obtained that satisfies the user's criteria for acceptance.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates the components of an AVM report;

FIG. 2 illustrates a block diagram of the vendor, host and user computers.

FIG. 3 illustrates a system diagram of the present invention;

FIG. 4 illustrates the unordered cascading AVM ordering sequence with confidence scores and corresponding standardized values;

FIG. 5 illustrates the ordered cascading AVM ordering sequence with confidence scores and corresponding standardized values;

FIG. 6 illustrates a flow chart of the present invention;

FIGS. 7-11 illustrates an example of the present invention.

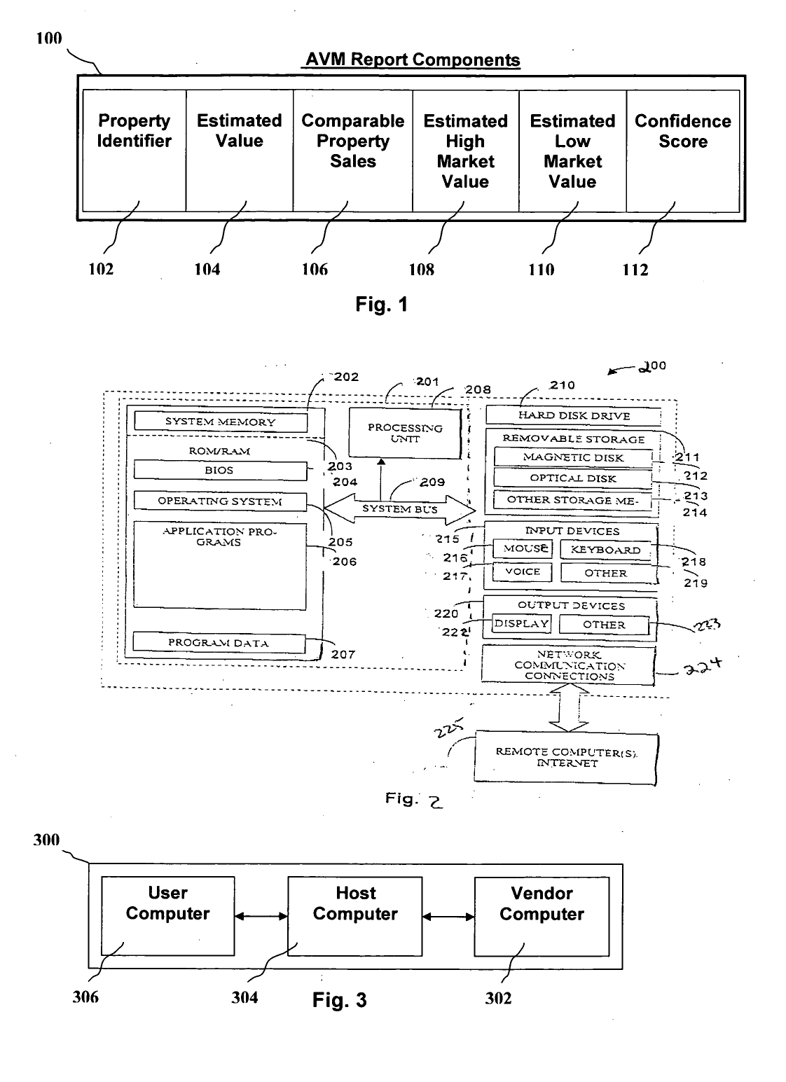

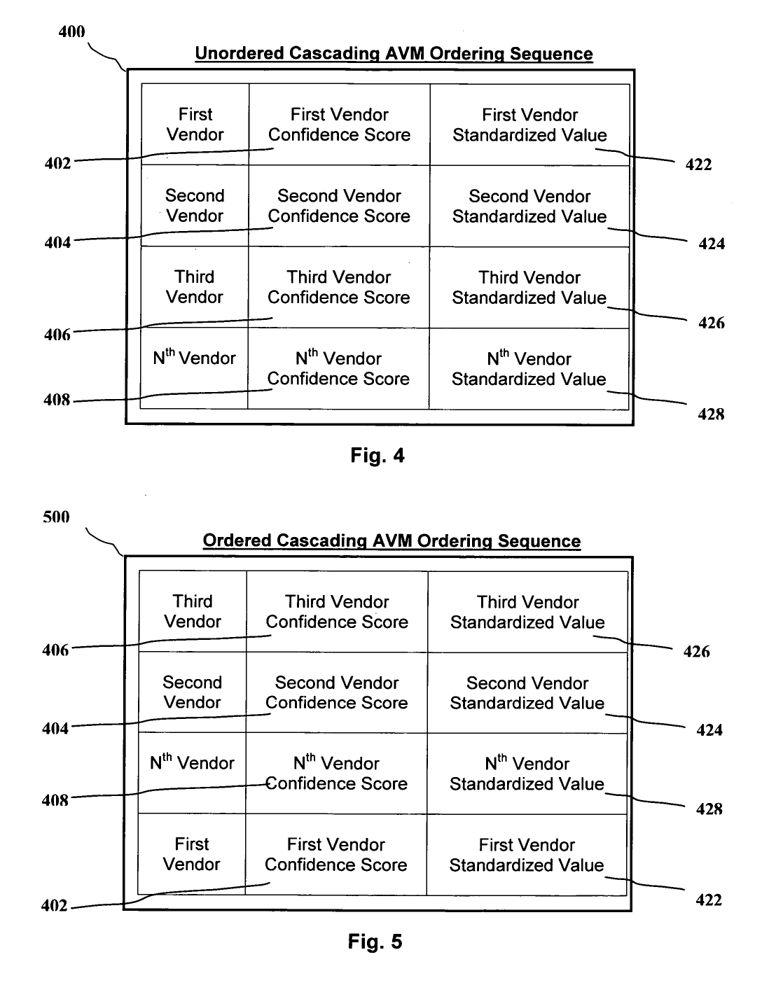

### DETAILED DESCRIPTION OF THE INVENTION

AVM vendors produce confidence scores using statistical modeling. On a per report basis, AVM vendor computers perform an analysis of the quality and relevance of the data used to calculate an estimated market value for a subject property, such as comparable sales, to generate a confidence score.

AVM vendors often use proprietary methods for generating confidence scores given on their AVM reports. Each AVM vendor defines a confidence scoring scale and corresponding meaning of their confidence scores. For example, one AVM vendor may provide confidence scores based on a scale between 1 and 100 with 100 representing the best expected accuracy. Another AVM vendor may use a scale of “H, M, L” for “High, Medium and Low” with H representing the best expected accuracy. AVM vendors provide a definition of what their confidence scores mean in terms of expected accuracy. For example, one AVM vendor's confidence score corresponds to the percentage chance the AVM report's estimated market value is within 10% of the true market value, thus a confidence score of 85 would mean this AVM vendor's AVM report's estimated market value has an 85% probability of being within 10% of the actual market value.

Ultimately most AVM vendors have a confidence score scale that correlates to the expected accuracy of the estimated market value given on each AVM report. One method for quantifying the accuracy of AVM estimated values and corresponding confidence scores is to perform an AVM test for a batch of properties with known market values, such as recent real estate purchase prices. AVM tests are typically performed by comparing the known values or reference values of a batch a of real estate properties and comparing each AVM's estimate of market value for the same properties to see how close each AVM's estimate of market value came to the reference values. The observed error between the AVM estimated values and reference values is quantified and then correlated to each AVM's original confidence score scale. For example, a test may show that a particular AVM vendor's AVM report's confidence score of 75 had an observed average error rate of a 12%.

FIG. 3 illustrates a system 300 which allows users to access online services such as AVM reports 100, which includes a vendor computer 302 which produces the AVM reports 100 a host computer 304 which obtains the AVM reports 100 from the vendor computer 302 where the host computer 304 may be used to execute the software of an embodiment of the present invention, and a user computer 306 which obtains the AVM reports 100 from the host computer 304. FIG. 2 shows a block diagram of the one of the computers 302, 304, 306 of the system 300 shown in FIG. 3. Although FIG. 3 illustrates the vendor computer 302, host computer 304 and the user computer 306, additional vendor, host and user computers are within the scope of the embodiment. The system 300 includes output devices 220, such as, but not limited to, a display 222, and other output devices 223; input devices 215 such as, but not limited to, a mouse 216, a voice input device 217, a keyboard 218 and other input devices 219; removable storage 211 that may be used to store and retrieve software programs incorporating code that aids or executes the embodiment or stores data for use with the embodiment, or otherwise interacts with the embodiment, such as, but not limited to, magnetic disk storage 212, optical storage 213 and other storage 214, a hard drive 210 that may be used to store and retrieve software programs incorporating code that aids or executes the embodiment or stores data for use with the embodiment, or otherwise interacts with the embodiment; and system components, such as those within dashed line 201, including but not limited to system memory 202, which includes BIOS (Basic Input Output System) 204, RAM (Random Access Memory) and ROM (Read Only Memory) 203, an operating system 205, application programs 206, program data 207, a processing unit 208, system bus 209, and network and or communications connections 224 to remote computers, an intranet which access is available to members of the organization and/or the Internet 225. Examples of such systems 300 includes without limitation personal computers, digital assistants, smart cellular telephones and pagers, dumb terminals interfaced to an application server and the like. The network includes various topologies, configurations, and arrangements of network interconnectivity components arranged to interoperability couple with enterprise, wide area and local area networks and include wired, wireless, satellite, optical and equivalent network technologies. The term cascading AVM engine will mean the cascading AVM engine of the present invention. The Internet has various online services providers for which a user may wish to obtain the service. These service providers, referred to as vendors of an automated valuation models provide various services, and among the services that they provide is an AVM report 100. The present invention is directed to the field of valuation methods for real estate property using Automated Valuation Model (AVM) reports 100. For the present invention, a Cascading AVM search method has been developed that ensures that the AVM reports 100 received will have the Confidence Score 112 with the best expected accuracy with the objective of maximizing the accuracy of the AVM reports 100 received.

The present invention discloses a method and system of providing an estimated market value 104 of a real estate property identified 102 using data from multiple AVM vendors, where the method includes the host computer 304 running a software program that communicates via an online connection with other vendor computers 302 that provide AVM reports 100. The host computer 304 runs a software program that electronically requests the Confidence Score 112 values from multiple vendor computers 302 for a given real estate property identifier 102; the host computer 304 creates a table 400 containing the first vendor confidence score 402 obtained from a first vendor, the second vendor confidence score 404 obtained from a second vendor, a third vendor confidence score 406 obtained from the third vendor and the Nth vendor confidence score 408 obtained from a Nth vendor. The cascading AVM ordering sequence for confidence scores 402, 404, 406, 408 initially has not been placed in any particular order. The host computer 304 running a software program looks up and assigns a standardized value 422,424,426,428 to each received AVM vendor's Confidence Score value so that the standardized values 422, 424, 426, 428 assigned to each Confidence Score 402, 404, 406, 408 can be sorted from highest to lowest. The standardized value 422,424,426,428 corresponds to the expected accuracy of the Confidence Scores in table 400. Expected accuracy data can be obtained through AVM testing or other means such as the defined accuracy of each AVM vendor's confidence scoring system. A host computer 304 running a software program determines which AVM vendor correspond to the standardized values and Confidence Score 112 values 402, 404, 406, 408; a computer running a software program sorts table 400 by the standardized values 422, 424, 426, 428 from the highest standardized value 422, 424, 426, 428 to the lowest standardized value 422, 424, 426, 428. The host computer 304 running a software program forms a table 500 which lists the standardized values 422,424,426,428 from highest to lowest. The table 500 has placed the third confidence score 406 from the third vendor at the top because the third standardized value 426 has the highest value. The next highest standardized value 424 which corresponds to the second confidence score 406 from the second vendor. The lowest standardized value 422 which corresponds to the first confidence score 402 from the first vendor. The host computer 304 running a software program sets the AVM order sequence of AVM reports 100 to be ordered from the respective vendor computers 302 in the order of the corresponding sorted standardized values 422,424,426,428 as shown in table 500. As illustrated in FIG. 5, the host computer 304 running a software application would first order the AVM report 100 from the third vendor and then from the second vendor in the ordering sequence shown in table 500 of FIG. 5. When retrieving the AVM confidence score, the confidence score is checked against any minimum confidence score and/or standardized value criterion that might have been set by the user. If the confidence score 402, 404, 406, 408 and/or standardized value 422, 424, 426, 428 for the property for a given property identifier do not meet or exceed minimum user defined criterion, then this AVM report 100 is not ordered, thus the host computer 304 running a software application performs the same confidence score and standardized value validation for the next AVM vendor in the sequence in table 500. If the next AVM confidence score and/or standardized value meet the minimum defined criterion, the AVM report 100 is ordered. The host computer 304 sends the results to the user computer 306. Additional AVM cascading rules may be defined by the user whereas AVM reports 100 will be ordered in the sequence illustrated in table 500 until all user defined rules have been satisfied or all of the AVM vendors in the cascade has been queried, whichever comes first.

An additional feature of the present invention is that the computer running a software program can utilize a mixture of methods for ordering AVM reports 100 where the AVM report 100 ordering sequence can be dynamically determined by the expected accuracy of the Confidence Score 112 values for some of the AVM reports 100 while the other AVM reports 100 can be ordered in a predetermined sequence defined by the user. The mixed use of methods works by allowing the user to define which AVM reports 100 will be ordered in an ordering sequence which is dynamically determined per Confidence Score 112 and which AVM reports 100 will be ordered in a fixed ordering sequence during the Cascading AVM search. With this mixed method approach, once the ordering sequence of the AVM reports 100 that have been set to dynamically sequence per the standardized values per Confidence Score 112, then the entire AVM report ordering sequence is then set and executed. For example, the AVM Cascading Engine of the present invention could be setup to order from five AVM vendor computers 302 which supply AVM reports 100. The first three positions in the AVM ordering sequence out of the five AVM vendors could be setup to dynamically be determined whereas the remaining two AVM vendors could be set to be ordered in a defined sequence to be the fourth and fifth AVM reports to be ordered where one AVM vendor is always fourth in the ordering sequence and the other AVM vendor is always fifth in the ordering sequence. For purposes of example, these five vendor computers 302 could be identified as HVE, CASA, VeroVALUE, HPA, and PASS where the first three positions in the AVM ordering sequence is set to be dynamically determined by the Confidence Score 112 value obtained from the vendor computers 302 associated with HVE, CASA and VeroVALUE. The AVM report 100 ordering sequence for the vendor computers 302 associated with HPA and PASS can be set where HPA is set as the fourth AVM report to be ordered and PASS is the fifth and last AVM report in the ordering sequence to be ordered. HPA and PASS would be ordered after the ordering sequence for HVE, CASA and VeroVALUE has been dynamically determined and then the AVM Cascade ordering sequence has been executed for HVE, CASA and VeroVALUE. In this example, when the host computer 304 submits an AVM Cascade search request for a property identifier 102, the Cascading AVM Engine of the present invention would request the Confidence Scores 112 from vendor computers 302 associated with HVE, CASA and VeroVALUE. Upon receiving the Confidence Score 112 values, the Cascading AVM Engine would assign a standardized value to each Confidence Score 112 value received and then sort the first three positions of the Cascading AVM ordering sequence for HVE, CASA and VeroVALUE by the standardized values of the Confidence Scores 112 received for these three AVMs from the highest to the lowest. If, in this example, the Cascading AVM Engine determined that the standardized value for the Confidence Score 112 from the vendor computer 302 associated with CASA had the highest standardized value associated with the Confidence Score 112 then the Confidence Score 112 from the vendor computer 302 associated with VeroVALUE had the second-highest standardized value associated with the Confidence Score 112 and then the standardized value associated with the Confidence Score 112 from the vendor computer 302 associated with HVE had the third-highest standardized value associated with the Confidence Score 112, the Cascading AVM Engine would set the ordering sequence to obtain the first AVM report 100 from the vendor computer 302 associated with CASA to be ordered first then the ordering sequence would be set to obtain the second AVM report 100 from the vendor computer 302 associated with VeroVALUE, then the ordering sequence would be set to obtain the third AVM report 100 from the vendor computer 302 associated with HVE. The ordering sequence would then be set to obtain the fourth AVM report 100 from the vendor computer 302 associated with HPA and the ordering sequence would be set to obtain the fifth AVM report 100 from the vendor computer 302 associated with PASS. If the first AVM report 100 associated with CASA is obtained and does not satisfy any defined criteria for acceptance, then the Cascading AVM Engine would order the second AVM report 100 from the vendor computer 302 associated with VeroVALUE and continue this process throughout the sequence set for this Cascading AVM Search until all defined criteria for acceptance have been satisfied or the Cascading AVM search has been exhausted, whichever comes first.

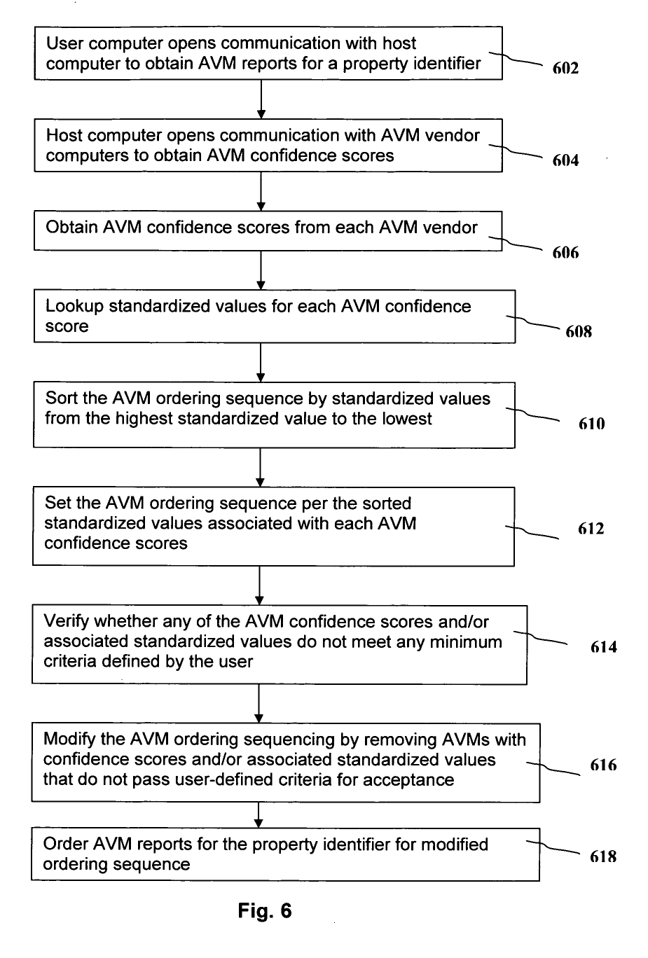

The steps of the present invention are summarized in FIG. 6. More particularly FIG. 6 illustrates that the user computer opens communication with the host computer to obtain the AVM report in step 602 and that the host computer opens communication with each vendor computer to obtain the Confidence Score 112 in step 604. In step 606, the Confidence Score 112 is obtained from each vendor computer, and in step 608 the standardized value is assigned to each Conference Score 112 value. In step 610, the AVM ordering sequence is sorted by the associated standardized values from highest to lowest. In step 612, the AVM ordering sequence is set whereby the standardized values are ordered from highest to lowest. In step 614, it is verified whether or not the AVM confidence scores and/or standardized values do not meet defined minimum criteria for acceptance. In step 616, the AVM reports with a Confidence Score 112 and/or standardized value that do not meet a minimum defined criteria are removed from the ordering AVM sequence. In step 618, AVM reports 100 are ordered in accordance with the modified AVM ordering sequence.

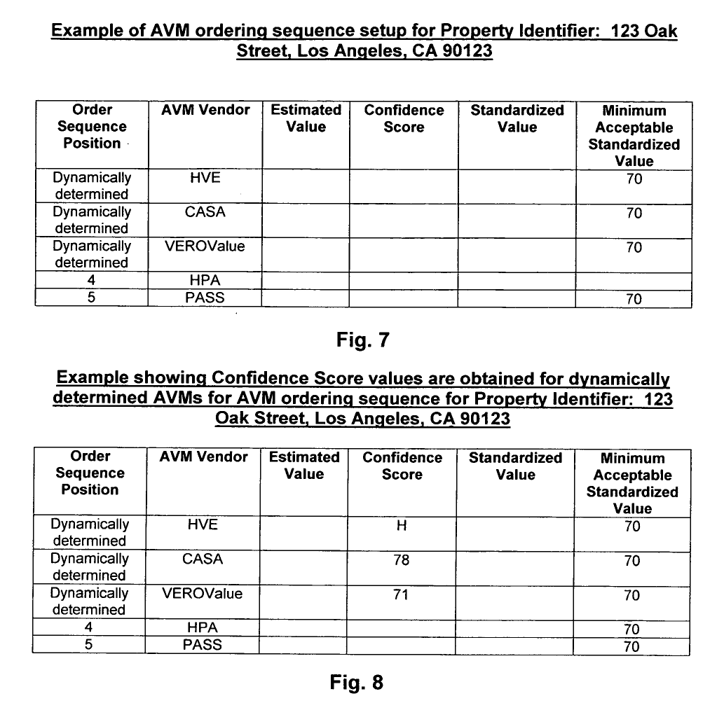

FIGS. 7-11 illustrates an example of the present invention.

In FIG. 7, the AVM ordering sequence is defined where the first three positions in the ordering sequence are dynamically determined to be followed by HPA in the fourth postion and PASS in the fifth and last position. The user has set a minimum acceptable standardized value for each AVM in the AVM ordering sequence. The first three AVM vendors, namely HVE, CASA, and VEROValue have the ordering sequence position dynamically determined while the last to two AVM vendors, namely HPA and PASS have the ordering sequence position set at 4 and 5 respectively.

In FIG. 8, the host computer 304 obtains the confidence score from dynamically determined AVM vendors associated with HVE, CASA and VEROValue.

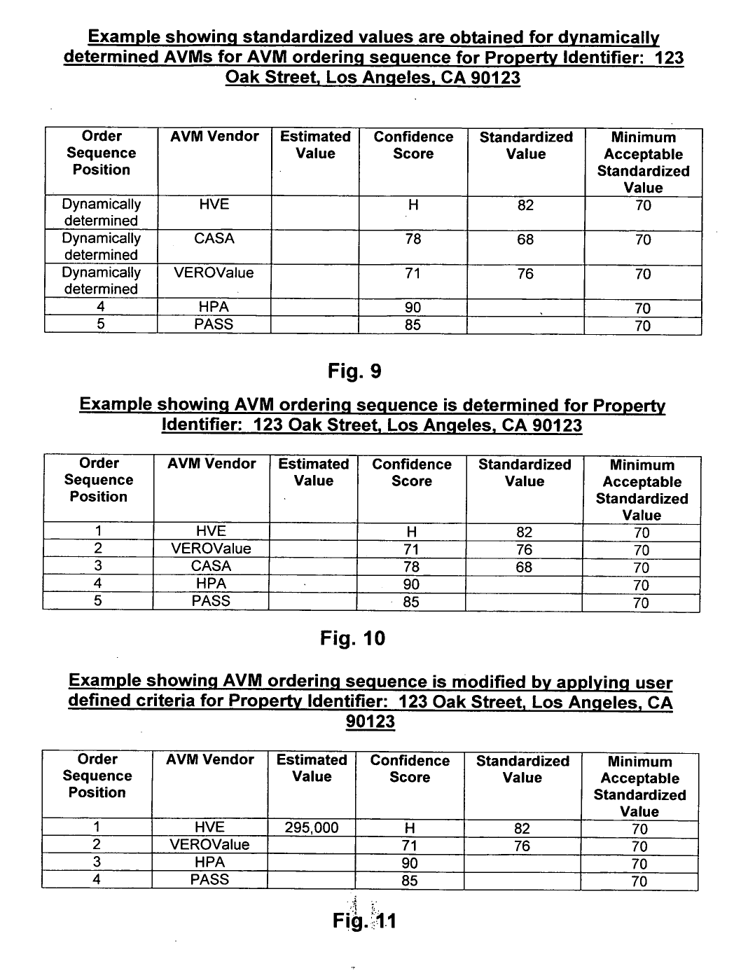

In FIG. 9, the host computer 304 determines the standardized value for dynamically determined AVM vendors associated with HVE, CASA and VEROValue. In FIG. 10, the host computer 304 determines the ordering sequence for the dynamically determined AVM vendors associated with HVE, CASA and VEROValue by sorting the standardized values from highest to lowest for these three vendors. It can be seen that HVE had the highest standardized value, then VEROValue and then CASA and are set to ordering positions of 1, 2, and 3 respectively. In FIG. 10, the entire ordering sequence can now be determined with HPA and PASS in ordering sequence positions 4 and 5 respectively. In FIG. 11, the AVM vendor associated with CASA is removed from the ordering sequence because the standardized value of 68 is below the minimum acceptable standardized value of 70. It should be noted that the example above and the could be embodiment of the present invention could be accomplished by converting a Confidence Score 112 to a standardized value rather than associating a standardized value to an AVM's Confidence Score 112.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A method for obtaining a real estate valuation using an automated valuation model (AVM), comprising the steps of:
accessing an AVM confidence score corresponding to a real estate property for said real estate valuation;
forming a plurality of confidence scores from accessing said confidence scores;
assigning said plurality of confidence scores to a plurality of standardized values;
arranging said plurality of standardized values from highest to lowest;
selecting an automated valuation model report based on said arrangement of said plurality of standardized values.

2. A method for obtaining a real estate valuation using an automated valuation model as in claim 1, wherein the step of said automated valuation model report are not ordered if said standardized values of said automated valuation model report does not meet a predetermined criterion.

3. A method for obtaining a real estate valuation using an automated valuation model as in claim 1, wherein the step of selecting includes the step of forming an ordering sequence to order said automated valuation model report.

4. A method for obtaining a real estate valuation using an automated valuation model as in claim 3, wherein said ordering sequence is modified based on a condition.

5. A method for obtaining a real estate valuation using an automated valuation model as in claim 4, wherein said condition is a predefined condition.

6. A method for obtaining a real estate valuation using an automated valuation model s in claim 3, wherein said ordering sequences is modified based on the source of the automated valuation model report.

7. A method for obtaining a real estate valuation using an automated valuation model as in claim 1, wherein the confidence score is be formed by a host computer.

8. A method for obtaining a real estate valuation using an automated valuation model as in claim 1, wherein the method includes the step of accessing said confidence score by a host computer.

9. A method for obtaining a real estate valuation using an automated valuation model as in claim 1, wherein said the method includes the step of accepting the automated valuation model report if the automated valuation model report meets all conditions.

10. A method for obtaining a real estate valuation using an automated valuation model as in claim 9, wherein the method includes the step of not ordering another automated valuation model report if the automated valuation model report meets all conditions.

11. A system for obtaining a real estate valuation using an automated valuation model, comprising:
a computer for accessing an confidence score corresponding to a real estate property for said real estate valuation;
said computer for forming a plurality of expected confidence scores from accessing said expected confidence score;
assigning said plurality of confidence scores to a plurality of standardized values;
said computer arranging said plurality of standardized values from highest to lowest;
said computer selecting an automated valuation model report based on said arrangement of said plurality of standardized values.

12. A system for obtaining a real estate valuation using an automated valuation model as in claim 11, wherein the computer does not order said automated valuation model if said confidence score of said automated valuation model report does not meet a predetermined criterion.

13. A system for obtaining a real estate valuation using an automated valuation model as in claim 11, wherein the computer forms an ordering sequence to order said automated valuation model report.

14. A system for obtaining a real estate valuation using an automated valuation model as in claim 13, wherein the computer modifies said ordering sequence based on a condition.

15. A system for obtaining a real estate valuation using an automated valuation model as in claim 14, wherein said condition is a predefined condition.

16. A system for obtaining a real estate valuation using an automated valuation model in claim 13, wherein said ordering sequences is modified by the computer based on the source of the automated valuation model report.

17. A system for obtaining a real estate valuation using an automated valuation model as in claim 11, wherein the step of accessing a confidence score is formed by a user computer.

18. A system for obtaining a real estate valuation using an automated valuation model as in claim 11, wherein the system includes a vendor computer to generate said confidence score.

19. A system for obtaining a real estate valuation using an automated valuation model as in claim 1, wherein said computer accepts the automated valuation model report if the automated valuation model report meets all conditions.

20. A system for obtaining a real estate valuation using an automated valuation model as in claim 19, wherein the computer stops ordering another automated valuation model report if the automated valuation model report meets all conditions.

21. A method for obtaining a real estate valuation using an automated valuation model as in claim 1, wherein said step of assigning includes the step of converting the confidence scores.
